(19) United States
(12) Patent Application Publication
(10) Pub. No.: US 2014/0058977 A1
(43) Pub. Date: Feb. 27, 2014

(54) Method, System, and Computer Program Product for Evaluating Securities Value

(71) Applicant: Kuo-Tsai Hu, Taoyuan (TW)

(72) Inventor: Kuo-Tsai Hu, Taoyuan (TW)

(21) Appl. No.: 13/971,453

(22) Filed: Aug. 20, 2013

(30) Foreign Application Priority Data
Aug. 23, 2012 (TW) 101130681
Mar. 27, 2013 (TW) 102110777

(51) Int. Cl. G06Q 40/06

(52) U.S. Cl. CPC G06Q 40/06
USPC 705/36 R

(57) ABSTRACT

A computer-implemented method, system and computer program product for evaluating securities investment value, through using accounting based data to generate value factors and evaluation factors of at least one financial object, and then an expected price of the financial object in the last year of a plurality of predication years may be generated. A requested return rate may be selected, and then a fair value of the financial object may be generated. A fair ratio of the financial object may be determined and an expected return rate may be generated. Once the fair value or the expected return rate is obtained, it may be used as a basis to evaluate the investment value of the financial object. The value ratio or the expected return rate may be used as a basis to compare the relative investment value among financial objects in the plurality of securities.

### CROSS-REFERENCE TO RELATED APPLICATIONS

This application claims the priority of Republic of China Patent Application No. 101130681 filed on Aug. 23, 2012 and No. 102110777 filed on Mar. 27, 2013, in the State Intellectual Property Office of the R.O.C., the disclosure of which is incorporated herein by reference.

### BACKGROUND OF THE INVENTION

1. Field of the Invention

The invention relates generally to securities investment, and more particularly to a method, system, and computer program product for evaluating securities value.

2. Descriptions of the Related Art

As Benjamin Graham, a security analysis pioneer stated: “An investment operation is one which, upon thorough analysis, promises safety of principal and a satisfactory return . . . ” in which the “satisfactory return” refers to not only cash dividends, but also capital gain of principal, the gained return rate would count once the investor has performed comprehensive analysis and is willing to accept, no matter what rate of return is assumed.

The major concept of value investing is based on two core principles: margin of safety and risk diversification. It is easier to know than to do for an investor to implement a robust investment principle in a rapidly changing securities market. Currently, the conventional methods require value investors not only to spend much time in gathering and summarizing securities related data, but also to set various parameters for evaluating securities value. However, to amateur investors, it is difficult to follow predetermined investment decision-making criteria for selecting securities, they are not even clear about the required parameter ranges, so that the effectiveness of value investing is always far less practical as expected.

To evaluate the securities value is the prerequisite and core of value investing, provides an important rational determination criterion, and is a value based on facts (for example, shareholder equity, net profit, cash dividend etc.). However, undeniably, market price is always a fundamental factor influencing investment value; especially, margin of safety is mainly determined by the price paid by investors; the higher the price is, the smaller the margin of safety is. Hence, the price is a critical factor to determine investment performance, as what underlined by Warren Buffett, “Of course, a business with terrific economics can be a bad investment if the price paid is excessive.”

In practice, there have been many evaluation methods developed gradually to address the feasibility and immediacy for securities evaluation. In one aspect, the use of one single indicator may suffer from hasty generalizing. For example, only focus on price-to-earnings ratio (PER), price-to-book ratio (PBR), price to revenue ratio, dividend yield, or return on equity (ROE). In another aspect, the data from short-term financial report may result in over short sighted investment direction, i.e., only refer to data of in the recent one year or quarter. In addition, the relevance of historical operational performance may be ignored easily if only predicted numbers are considered (for example, predicted PER, predicted earnings growth rate, or PEG indicator, that is, the expected growth rate of earning per share divided by PER).

Keynes, a famous economist, has said, “I would rather be vaguely right than precisely wrong”. Even though there is not a single indicator to show the completeness of an enterprise; the more complex an investment evaluation model is, the easier to cause large deviation by a minor miss. Thus, how to utilize relatively critical factors would be a key issue for the investors.

Currently, the conventional techniques, is lacking a robust investment architecture to manifest the relevance of historical performance and future returns, neither, there is a systematic quantification investment method to embody the securities investment value with a few key elements.

### SUMMARY OF THE INVENTION

In view of the above deficiencies and other problems of conventional technologies mentioned, one object of the invention is to provide a computer-implemented method, system and computer program product which includes robust investment architecture with critical evaluation factors to implement a value analysis concept in the invention. It manifests long-term operations performance and future value adding potential of corporations, as well as quantifies relative value between securities. Another objective of the invention is to simplify the work load and time cost of investors, and to improve the quality as they evaluate fair values of securities for investors to concentrate more on fundamentals to select investment targets for long-term orientation.

For the above purposes, one exemplary embodiment of the invention provides a method, system and computer program product for evaluating securities value.

In an embodiment, the present invention may be a computer-implemented method for evaluating securities value, including the following steps. Information of a plurality of securities is stored into a database, wherein the information may include identity, accounting data and price-to-earnings ratio (PER) of each of the plurality of securities; at least one financial object may be selected by the identity of the financial object on a valuation date, wherein the financial object may be one of the plurality of securities; value factors of the financial object may be generated based on the accounting data of the financial object, wherein the value factors may include historical return on equity (ROE), historical cash dividend payout ratio, book value per share in a base year and earnings per share (EPS) in the base year; the base year may be composed of four consecutive quarters before the valuation date; evaluation factors of the financial object in a plurality of prediction years after the base year may be generated based on the value factors of the financial object, wherein the evaluation factors may include: projected earnings per share, projected cash dividend per share, and projected book value per share; and an expected price of the financial object in the last year of the plurality of prediction years may be generated based on the evaluation factors and the historical price-to-earnings ratio of the financial object, wherein the historical price-to-earnings ratio is generated based on the price-to-earnings ratio of the financial object before the valuation date.

In this embodiment, the accounting data may include: book value per share, earnings per share and cash dividend per share.

In an embodiments, the historical price-to-earnings ratio may be a mathematical combination of a plurality of price-to-earnings ratio before a valuation date; wherein the plurality of price-to-earnings may include at least one of: a plurality of time periods, a plurality of years, a plurality of quarters, or a plurality of accounting periods; and wherein the mathematical combination may include at least one of: calculating a mathematical average of the plurality of price-to-earnings, calculating a mathematical weighted average of the plurality of price-to-earnings ratio, calculating a statistical mean of the plurality of price-to-earnings ratio, calculating a statistical median of the plurality of price-to-earnings ratio, calculating a midpoint of the plurality of price-to-earnings ratio, or calculating a minimum of the plurality of price-to-earnings ratio.

According to this embodiment, the historical price-to-earnings ratio may be obtained by using an itemized menu, wherein the itemized menu may be generated based on the mathematical combination of the plurality of price-to-earnings ratio.

In an embodiment, the historical return on equity may be a mathematical combination of a plurality of return on equity before a valuation date; wherein the plurality of return on equity may include at least one of: a plurality of time periods, a plurality of years, a plurality of quarters, or a plurality of accounting periods; and wherein the mathematical combination may include at least one of: calculating a mathematical average of the plurality of return on equity, calculating a mathematical weighted average of the plurality of return on equity, calculating a statistical mean of the plurality of return on equity, calculating a statistical median of the plurality of return on equity, calculating a midpoint of the plurality of return on equity, or calculating a minimum of the plurality of return on equity.

According to this embodiment, the historical return on equity may be obtained by using an itemized menu, wherein the itemized menu may be generated based on the mathematical combination of the plurality of return on equity.

In an embodiment, the historical cash dividend per share may be a mathematical combination of a plurality of cash dividend per share before the valuation date; wherein the plurality of cash dividend per share may include at least one of: a plurality of time periods, a plurality of years, a plurality of quarters, or a plurality of accounting periods; and wherein the mathematical combination may include at least one of: calculating a mathematical average of the plurality of cash dividend per share, calculating a mathematical weighted average of the plurality of cash dividend per share, calculating a statistical mean of the plurality of cash dividend per share, calculating a statistical median of the plurality of cash dividend per share, calculating a midpoint of the plurality of cash dividend per share, or calculating a minimum of the plurality cash dividend per share.

In one embodiments, to generate aforementioned evaluation factors of the financial object may include: calculating the projected cash dividend per share of the financial object in the first prediction year after the base year based on the earnings per share of the financial object in the base year and the historical cash dividend payout ratio of the financial object, wherein the first prediction year may be the first year not overlapped with the base year counted after the base year; calculating the projected earnings per share of the financial object in the first prediction year based on the book value per share of the financial object in the base year and the historical return on equity of the financial object; calculating the projected book value per share of the financial object in the first prediction year based on the book value per share of the financial object in the base year, the projected earnings per share of the financial object in the first prediction year, and the projected cash dividend per share of the financial object in the first prediction year; calculating the expected cash dividend per share of the financial object in the second prediction year based on the projected earnings per share of the financial object in the first prediction year and the historical cash dividend payout ratio of the financial object; wherein the second prediction year may be the second year, which is not overlapped with the first prediction year, counted after the base year; calculating the projected earnings per share of the financial object in the second prediction year based on the projected book value per share of the financial object in the first prediction year and the historical return on equity; and calculating the projected book value per share of the financial object in the second prediction year based on the projected book value per share of the financial object in the first prediction year, the projected earnings per share of the financial object in the second prediction year, and the projected cash dividend per share of the financial object in the second prediction year.

In an embodiment, at least one requested return rate may be selected, and a fair value of the financial object may be generated based on the requested return rate, the projected cash dividend per share of the financial object in the plurality of prediction years, and the expected price of the financial object in the last year of the plurality of prediction years; wherein the requested return rate may be a predetermined value larger than zero.

In this embodiment, the information may further include market price of each of the plurality of securities, a value ratio of the financial object may be generated by any ratio combination of the market price and the fair value of the financial object.

In one embodiment, information of the plurality of securities in the database may further include market price of each of the plurality of securities, and an expected return rate of the financial object may be generated based on the market price of the financial object, the projected cash dividend per share of the financial object in the plurality of prediction years, and the expected price of the financial object in the last one year of the plurality of prediction years. The expected return rate may consider not only capital gain between the market price and the expected price, but also cash flow from projected cash dividends. Investors may utilize the expected return rate to evaluate absolute investment value of the financial object or to compare relative investment values between different securities.

In this embodiment, the market price may include at least one of: a trading price which is real-time or delay times on said valuation date, a close price on said valuation date, a close price on the first trading day before the valuation date, or an average of close prices of a plurality of trading days before said valuation date.

In one embodiment, the plurality of securities may be selected from a universe, including at least one of: a sector, a market, a market sector, an industry sector, a geographic sector, or an international sector.

Additionally, one embodiment of the invention provides a computer program product embodied on a non-transitory computer readable medium for performing a method of evaluating securities value, which is loaded by a computer to execute the operations below. To couple to a database operative to store information of a plurality of securities, wherein the information may include identity, accounting data and price-to-earnings ratio of each of the plurality of securities; at least one financial object may be selected by the identity of the financial object on an valuation date, wherein the financial object may be one of the plurality of securities; value factors of the financial object may be generated based on the accounting data of the financial object, wherein the value factors may include: historical return on equity, historical cash dividend payout ratio, book value per share in a base year and earnings per share (EPS) in the base year; wherein the base year may consist of four consecutive quarters of which the accounting data are available before the valuation date; evaluation factors of the financial object in a plurality of prediction years after the base year may be generated based on the value factors of the financial object, wherein the evaluation factors may include: projected earnings per share, projected cash dividend per share, and projected book value per share; and an expected price of the financial object in the last one year of the plurality of prediction years may be generated based on the evaluation factors and the historical price-to-earnings ratio of the financial object, wherein the historical price-to-earnings ratio is generated based on the price-to-earnings ratio of the financial object before the valuation date.

In this embodiment, the accounting data may include: book value per share, earnings per share and cash dividend per share.

In this embodiment, the followings may be further included while executing the program: at least one requested return rate may be setup or selected, and a fair value of the financial object may be generated based on the requested return rate, the projected cash dividend per share of the financial object in the plurality of prediction years, and the expected price of the financial object in the last year of the plurality of prediction years; wherein the requested return rate may be a predetermined value larger than zero.

According to this embodiment, information of the plurality of securities may further include market price of each of the plurality of securities, and a value ratio of the financial object may be generated based on the market price and the fair value of the financial object.

In one embodiment, information of the plurality of securities may further include market price of each of the plurality of securities, and an expected return rate of the financial object may be generated based on the market price of the financial object, the projected cash dividend per share of the financial object in the plurality of prediction years, and the expected price of the financial object in the last year of the plurality of prediction years.

In an embodiment, the historical return on equity may be obtained with an itemized menu or a value filling method.

In an embodiment, the historical cash dividend payout ratio may be obtained with an itemized menu or a value filling method.

In an embodiment, the historical price-to-earnings ratio may be obtained with an itemized menu or a value entered.

Further, one embodiment of the present invention provides a securities information system for evaluating securities investment value, which may include: a database operative to store information of a plurality of securities, the information may include: identity, accounting data and price-to-earnings ratio of each of the plurality of securities; and a securities information process subsystem which may link to the database, may include: service secondary subsystem operative to select at least one financial object by the identity of the financial object on a valuation date, wherein the financial object is one of the plurality of securities; a data retrieval and storage secondary subsystem operative to at least one of access, or retrieve the information of the financial object from the securities database based on the identity of the financial object selected by the service secondary subsystem; and an evaluation secondary subsystem operative to link the data retrieval and storage secondary subsystem, and the evaluation secondary subsystem may include: a value factor module operative to generate value factors of the financial object based on the accounting data of the financial object provided by the data retrieval and storage secondary subsystem, wherein the value factors may include: historical return on equity, historical cash dividend payout ratio, book value per share in a base year, and earnings per share in the base year; wherein the base year may consist of four consecutive quarters with available accounting data before the valuation date; an evaluation factor module operative to generate evaluation factors of the financial object in the plurality of prediction years after the base year based on the value factors provided by the value factor module, wherein the evaluation factors may include projected earnings per share, projected cash dividend per share, and projected book value per share; and a securities information module operative to generate an expected price of the financial object in the last one year of the plurality of prediction years based on the evaluation factors provided by the evaluation factor module and historical price-to-earnings of the financial object, wherein the historical price-to-earnings ratio is calculated based on the price-to-earnings ratio of the financial object before the valuation date provided by the data retrieval and storage secondary subsystem.

The information of the plurality of securities in the database may further include market price of each of the plurality of securities. The securities information module may further generate an expected return rate of the financial object based on the expected price of the financial object in the last one year of the plurality of prediction years, the market price of the financial object provided by the data retrieval and storage secondary subsystem, and the projected cash dividend per share of the financial object in the plurality of prediction years provided by the evaluation factor module.

The service secondary subsystem may further include: a condition setting module operative to set or select at least one requested return rate, which may be a predetermined value larger than zero; and the securities information module may further generate a fair value of the financial object based on the expected price of the financial object in the last one year of the plurality of prediction years, the requested return rate provided by the condition setting module, and the projected cash dividend per share of the financial object in the plurality of prediction years provided by the evaluation factor module.

The information of the plurality of securities in the database may further include market price of each of the plurality of securities. The securities information module may further generate a value ratio of the financial object base on the fair value of the financial object here and the market price of the financial object provided by the data retrieval and storage secondary subsystem.

The service secondary subsystem may further include: a display interface module operative to display with an itemized menu based on a plurality of values larger than zero provided by the condition setting module; and an operation interface module operative to select at least one option in the menu to generate the requested return rate

In summary, from the computer-implemented method for evaluating securities investment value, the computer program product for storing securities information process program, and the securities information system, the present invention evaluates the safety margin of securities' market price by fair value, and instructs investors by the expected return rate for the criteria on whether incorporating the securities into investment portfolio or not. Therefore, compared to the existent securities investment value evaluation methods, the present invention constructs a robust investment architecture by utilizing the historical return on equity, historical cash dividend payout ratio, book value per share in the base year, and earnings per share in the base year of an enterprise as common value factors, instead of by regarding them as independent single indicator separately, such that not only the possibility to suffer from one-sidedness is reduced, but also simplification effect is achieved; also, the evaluation factors representing the future performance of the enterprise come from the value factors generated from the accounting based data relating to long-term operational performance of the enterprise to prevent investors from over-optimistic expectation for the expected price and the projected cash dividend per share; moreover, the fair value generated by the expected price, the projected cash dividend per share and a requested return rate selected may be used as a basis to estimate the current market price is over evaluated or under evaluated; thereby to become rational determination criteria of investment decision and investment discipline for concentration on long-term investment performance.

### BRIEF DESCRIPTION OF THE DRAWINGS

The above and other aspects, features and other advantages of the present invention will be more clearly understood from the following detailed description of exemplary embodiments, in conjunction with the accompanying drawings. In the drawings, like reference numerals generally indicate identical, functionally similar, and/or structurally similar elements.

FIG. 1 is a process flow diagram of a computer-implemented method for securities investment value evaluation in according with some exemplary embodiments of the present invention;

FIG. 2 depicts an exemplary embodiment of a computer system as may be used to implement the invention;

FIG. 3 depicts a block diagram of an exemplary embodiment of a system for a computer-implemented method of securities investment evaluation according to the invention;

FIG. 4 depicts another block diagram of an exemplary embodiment of a system for a computer-implemented method of securities investment evaluation according to the invention; and

FIG. 5 illustrates an exemplary user interface of a computing device with touch screen display in accordance with a preferred embodiment of the invention.

FIG. 6 illustrates another exemplary user interface of a computing device with touch screen display in accordance with a preferred embodiment of the invention.

### DETAILED DESCRIPTION OF THE PREFERRED EMBODIMENT

Embodiments of the present invention will now be described in detail with reference to the accompanying drawings. The present invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

Various exemplary embodiments of the invention are discussed in detail below including a preferred embodiment. While specific implementations are discussed, it should be understood that this is done for the purpose of describing particular embodiments only and is not intended to be limiting of the invention. A person skilled in the relevant art can recognize that other components, configurations, accounting data, and ratios may be used without parting from the spirit and scope of the invention.

The terminology used in the description of the invention is for the purpose of describing particular embodiments only and is not intended to be limiting of the present invention. As used in the description of the invention and the claims, the singular forms “a”, “an” and “the” are intended to include the plural forms as well, unless the context clearly indicates otherwise.

Some embodiments of the invention may include the specific features or characteristics in the following embodiments, but not every embodiment necessarily include the specific features, structure, or characteristics. Further, repeated use of the phrase “in one embodiment” or “in an exemplary embodiment” do not necessarily refer to the same embodiment, although they may.

In the following description and claims, the terms “coupled” and “linked”, along with their derivatives, may be used as synonyms for each other. The terms may mean that two or more elements are in direct physical or electrical contact, and may also mean that two or more elements are not in direct contact with each other, but yet still cooperate or interact with each other.

An exemplary embodiment of the invention may be implemented on a computing device(s), processor(s), computer(s) and/or communications device(s). Herein, a computer is an electronic calculation device, for example, personal computer, Table PC, work station, or server etc., but not limited thereto.

In accordance with some embodiments of the present invention, a computer may comprise one or more central processing units (CPU) or processors, which may be coupled to a data bus. The process may link to a memory via the data bus, the memory may include, e.g., but not limited to, a hard disk, an optical disk drive, or a flash memory. The data bus may also link to display and input interface of a display interface, for example, touch panel, mouse, keyboard, or other input devices, but not limited thereto.

In the following description and claims, the terms such as “processing”, “calculating”, “generating”, “determining” or the like, refer to the action and/or process of a computer or similar electronic computing device that manipulate and/or transform data. Similarly the term “processor” may refer to any device or portion of a device that processes electronic data from registers and/or memory to transform that electronic into other electronic data that may be stored in registers and/or memory.

Some exemplary embodiments of the present invention may include apparatuses for performing the operations herein. An apparatus may be particularly constructed for the desired purposes, or it may comprise a general purpose device selectively activated or reconfigured by a program stored in the device.

The computer system and/or computer program product under discussion will be described with greater specificity in the following exemplary embodiments.

According to one exemplary embodiment, the term “securities” mentioned in the present invention may include common stock, ETF (Exchange Traded Fund), mutual fund, or other financial commodities with accounting data for reference and use. The corporation, company or enterprise mentioned in the invention indicates a general concept, for example, stock issuance corporation, stock issuance corporation as investment target in ETF, and stock issuance as investment target in mutual fund.

In an exemplary embodiment, the accounting data mentioned in the present invention may be obtained or calculated from financial statement of an issuance company, the financial statement may be quarterly financial statement, half yearly financial statement, annual financial statement, or annual report.

The term “year” mentioned in examples is not limited to a calendar year or a fiscal year in which a corporation operates, but is an year composed of four consecutive quarters, wherein no overlapped quarter exists between different years, and each of two adjacent years has one quarter to be adjacent to another quarter of the other year.

In the following description and claims, the shareholder equity and the book value (net value) may be synonyms for each other.

In an exemplary embodiment, name and/or identity of financial object mentioned in the present invention may be any symbol capable of representing securities identity of a securities issuance corporation, such as abbreviation, securities ticker, or securities code etc.

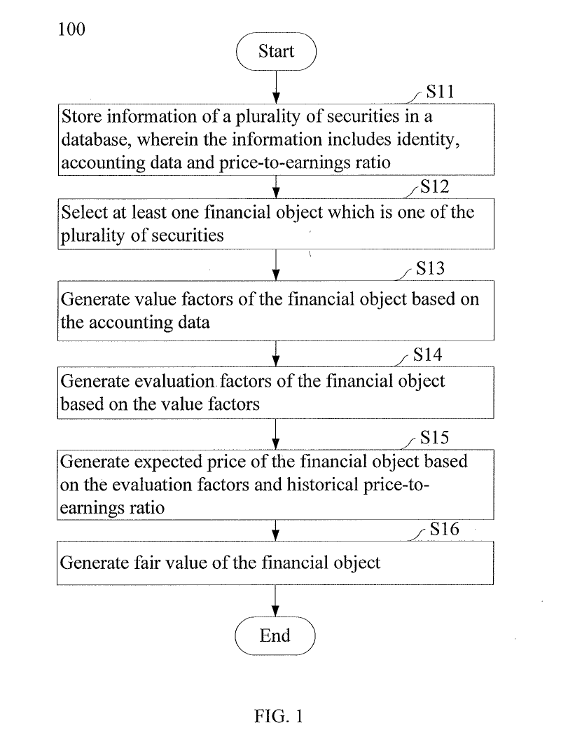

FIG. 1 depicts an exemplary process flow diagram 100 of showing a computer-implemented method for securities value evaluation according to the present invention. In an exemplary embodiment, referring now to FIG. 1, in step S11 of flow 100, a database receives and stores information of a plurality of securities using a computing system. The computing system comprises at least a processor and a memory. In one example, the memory may store both the database and a computer software application. The computer software application comprises a plurality of instruction routines, which are executed by the processor to carry out particular following steps in the method of the present invention. In another example, the software application and the database may be existed in the separate computing systems. Wherein, the database may be contained within a single computer system, or distributed among multiple computer systems. The information may include identity, accounting data and price-to-earnings ratio of each financial object in the plurality of securities.

The plurality of securities may be selected from a predetermined universe. In one exemplary embodiment, the plurality of securities are the all stocks and ETFs in US Stock Market including NYSE and NASDAQ. In another embodiment, the plurality of securities may include each stocks listed in the Stock Markets in Europe Union. In yet another embodiment, the plurality of securities may be selected to include all major technology stocks in the world.

In one embodiment, the database can store information identifying each financial object it contains, such as the name and/or symbol of the stock. Other data relating to each financial object before a valuation date can also be entered and stored in the database. The information source may be public information from the Securities and Exchange Commission, available financial statements and institutional investor conference for listed and OTC firms, or summarized information related to accounting data of listed firms provided by financial information corporations.

In an exemplary embodiment, the accounting data may include book value per share (BVPSi), earnings per share (EPSi) and cash dividend per share (CDPSi) of a plurality of historical years (Yi).

In another exemplary embodiment, the accounting data may include net shareholder equity (BVi), net income after tax (PATi) and total amount of cash dividends (CDi).

In some embodiments, the index i is an integer from 0 to −m+1 and m is a natural value. The history year with larger index i is closer to the valuation date. That is, Y₀ indicates the historical year in the plurality of historical years closest to the valuation date (hereinafter referred to as base year), and Y₋ₘ₊₁ indicates the historical year in the plurality of historical years farthest to the valuation date.

In one exemplary embodiment, the historical price-to-earnings ratio (PER_{history}) may be average PER_{average} or median PER_{median} of price-to-earnings ratio (PERi) in the plurality of historical years before the valuation date. The exemplary formula of PER_{average} is as below:

$${PER}_{average} = \frac{{\sum }_{i = 0}^{- m + 1} {PER}_{i}}{m}$$

In another exemplary embodiment, PER_{history} may be the minimum of the price-to-earnings ratio (PERi) in the plurality of historical years before the valuation date.

In yet another exemplary embodiment, PER_{history} may be the price-to-earnings ratio PER₀ of the base year Y₀.

In one exemplary embodiment, the price-to-earnings ratio PERᵢ in each year of the historical years Yᵢ may be obtained directly from company annual report.

In another exemplary embodiment, the PERi of each historical year Yi may be annual average price (Pi) divided by earnings per share (EPSi) in each historical year Yi; wherein the annual average price Pi may by the total trading amount divided by total trading shares for annual stock trading of securities in each historical year Yi. The exemplary formula is as below:

$${PER}_{average} = \frac{{\sum }_{i = 0}^{- m + 1} {P}_{i}}{{\sum }_{i = 0}^{- m + 1} {EPR}_{i}}$$

Referring again to FIG. 1, in step S12 of flow 100, at least one financial object is selected by the identity of the financial object on a valuation date. The financial object is one of the plurality of securities; the valuation date may be one of any day for a user to apply the computer-implemented method according to the present invention.

In one exemplary embodiment, the selecting at least one financial object by the identity of the financial object may be to enter a name of the financial object by an input device (for example, keyboard, touch panel) of a computer. The securities name may be a ticker symbol (for example, “AA” or “SPY”) or a short name of the corporation or an entity (for example, “Alcoa” or “SPDR S&P 500”), but not limited thereto.

In another exemplary embodiment, the selecting the financial object may be to click an identity of the financial object by an input device (for example, mouse or touch panel) of a computer. The financial object is one of the plurality of securities.

Referring again to FIG. 1, subsequently, in step S13 of flow 100, value factors of the financial object are generated based on the accounting data of financial object. The value factors comprise: historical return of equity (ROE_{history}), historical cash dividend payout ratio (CDR_{history}), book value per share (BVPS₀) in a base year Y₀ and earnings per share (EPS₀) in the base year Y₀. Herein, the base year Y₀ may consist of four consecutive quarters with accounting data available before the valuation date.

In an embodiment, the historical return on equity ROE_{history} is the average (ROE_{average}) or median (ROE_{median}) of the return on equity ROEᵢ in the plurality of historical years before the valuation date; in another embodiment, the historical return on equity ROE_{history} is the minimum of the return on equity ROEᵢ in the plurality of historical years; in yet another embodiment, the historical return on equity ROE_{history} is the return on equity ROE₀ of the base year, wherein the index is an integer value from 0 to −(m−1) and m is an integer. The historical year Yi with larger index i is closer to the evaluation day, and the historical year with i=0 is the base year Y₀.

In one embodiment, the return on equity ROEᵢ in each historical year Yᵢ may be obtained from corporate annual financial report directly.

In another embodiment, the return on equity ROEᵢ in each historical year Yᵢ can be calculated by dividing the earnings per share EPSᵢ of the historical year Yᵢ by the book value per share BVPS₍ᵢ₋₁₎ in the previous one historical year Y₍ᵢ₋₁₎, that is, ROEᵢ=EPSᵢ/BVPS₍ᵢ₋₁₎.

In yet another embodiment, the return on equity ROEᵢ of each historical year Yᵢ can be calculated by dividing the net income after tax PATᵢ of the historical year Yᵢ by the reported common shareholders equity BV₍ᵢ₋₁₎ of the previous one historical year Y₍ᵢ₋₁₎, that is, ROEᵢ=PATᵢ/BV₍ᵢ₋₁₎.

The average ROEaverage of the return on rate ROEᵢ of the plurality of historical years may be defined in two approaches as follows:

$${ROE}_{average} = \frac{{\sum }_{i = 0}^{- m + 1} {EPS}_{i}}{{\sum }_{i = - 1}^{- m} {BVPS}_{i}}$$

$${ROE}_{average} = \frac{{\sum }_{i = 0}^{- m + 1} {ROE}_{i}}{m}$$

According to an exemplary embodiment, the historical return on equity may be obtained by an itemized menu or a value filling. The itemized menu may include value selection approaches such as pull-down, sliding, or button pressing etc., but not limited thereto.

In one exemplary embodiment, the historical cash dividend payout ratio CDR_{history} is the average CDR_{average} of the cash dividend payout ratios CDRᵢ of the plurality of historical years before the valuation date; In another embodiment, the historical cash dividend payout ratio CDR_{history} is the cash dividend payout ratio CDR₀ of the base year, wherein the index i is an integer value from 0 to −(m−1) and m is an integer, the larger the index i links to the historical year Yi closer to the valuation date, the historical year linked to i=0 is the base year Y₀.

In one exemplary embodiment, the cash dividend payout ratio CDRᵢ of each historical year Yᵢ is the cash dividend per share CDPSᵢ of the historical year Yᵢ from cash dividend policy announced by the corporate divided by the earnings per share EPS₍ᵢ₋₁₎ of the previous historical year Y₍ᵢ₋₁₎, that can be written as,

$${CDR}_{i} = \frac{{CDPS}_{i}}{{EPS}_{( i - 1 )}} .$$

In another exemplary embodiment, the cash dividend payout ratio CDRᵢ of each historical year Yᵢ may be total amount of cash dividend CDᵢ of each historical year Yᵢ divided by the net income after tax PAT₍ᵢ₋₁₎ of the previous one historical year Y₍ᵢ₋₁₎, that can be written as

$${CDR}_{i} = \frac{{CD}_{i}}{{PAT}_{( i - 1 )}}$$

The average CDR_{average} of the cash dividend payout ratios CDRᵢ of the plurality of historical years may be generated in two approaches, as below:

$${CDR}_{average} = \frac{{\sum }_{i = 0}^{- m + 1} {CDPS}_{i}}{{\sum }_{i = - 1}^{- m} {EPS}_{i}}$$

$${CDR}_{average} = \frac{{\sum }_{i = 0}^{- m + 1} {CDR}_{i}}{m}$$

Because the cash dividend payout ratio CDRᵢ of each historical year Yᵢ may be zero, the historical cash dividend payout ratio may be zero, or the expected cash dividend per share may be zero.

In one embodiment, the historical cash dividend payout ratio CDR_{history} generated based on the cash dividend payout ratios CDRᵢ of the plurality of historical years may be obtained by an itemized menu or a value filling process.

In one embodiment, the base year Y₀ may be composed of four quarters, which may be four consecutive quarters with accounting data available before the valuation date. In one example, a corporate with publically issued stocks may release quarterly financial statements. From these quarterly financial statements, based on the quarter with released financial statement and closest to the valuation date, in addition to the previous three closest quarters with released financial statements, the first historical year, that is, the base year Y₀, is resulted, and further, the second historical year Y₋₁ is composed of the four further previous years with released financial statements, and so forth to result in other historical years with four quarters included similarly, wherein quarters in different historical years are mutually exclusive.

In another embodiment, the base year may be a fiscal year with available annual financial accounting year before the valuation date. The accounting data regarding to, for example, annual price-to-earnings ratio, return on equity, earnings per share, cash dividend per share etc. are available from an annual financial statement to simplify the application calculation of the invention.

Referring again to FIG. 1, in step S14 of flow 100, the evaluation factors of the financial object in the plurality of prediction years after the base year are generated based on the value factors of the financial object. The evaluation factors may include projected earnings per share EPSⱼ, projected cash dividend per share CDPSⱼ and projected book value per share BVPSⱼ; wherein the index is an integer from 1 to n and n is a positive integer, and the prediction year with smaller index j is closer to the base year.

In one exemplary embodiment, generating evaluation factors of the financial object include: the projected earnings per share EPS₁ in the first prediction year Y₁ after the base year Y₀ is the book value per share BVPS₀ in the base year Y₀ multiplied by the historical return on equity ROE_{history}; wherein the first prediction year Y₁ is the first year not overlapped with the base year Y₀ after the base year Y₀; the projected cash dividend per share CDPS₁ in the first prediction year Y₁ is the earnings per share EPS₀ in the base year Y₀ multiplied by the historical cash dividend payout ratio CDR_{history}; the projected book value per share BVPS₁ in the first prediction year Y₁ is the book value per share BVPS₀ in the base year Y₀ added by the projected earnings per share EPS₁ in the first prediction year Y₁ followed by being subtracted by the projected cash dividend per share CDPS₁ in the first prediction year Y₁; the projected earnings per share EPS₂ in the second prediction year Y₂ after the base year Y₀ is the projected book value per share BVPS₁ in the first prediction year Y₁ multiplied by the historical return of equity ROE_{history}; the second prediction year Y₂ is the second year not overlapped with the first prediction year Y1 after the base year Y₀; the projected cash dividend per share CDPS₂ in the second prediction year Y₂ is the projected earnings per share EPS₁ in the first prediction year Y₁ multiplied by the historical cash dividend payout ratio CDR_{history}; and the projected book value per share BVPS₂ in the second prediction year Y₂ is the projected book value per share BVPS₁ in the first prediction year Y₁ added by the projected earnings per share EPS₂ in of the second prediction year Y₂ followed by being subtracted from the projected cash dividend per share CDPS₂ in the second prediction year Y₂. The other evaluation factors of the financial object in the other prediction years may be projected by similar processes.

In another exemplary embodiment, the projected cash dividend per share CDPS₁ in the first prediction year Y₁ may be the earnings per share EPS₀ in the base year Y₀ multiplied by the historical cash dividend payout ratio CDR_{history}, that is, CDPS₁=EPS₀×CDR_{history}, alternatively, CDPS₁=max [0, (EPS₀×CDR_{history})] if EPS₀ is negative because CDPS₁ should not be a negative value. The projected book value per share BVPS₁ in the first prediction year Y₁ may be the book value per share BVPS₀ in the base year Y₀ added by the projected earnings per share EPS₁ in the first prediction year Y₁ followed by being subtracted from the projected cash dividend per share CDPS₁ in the first prediction year Y₁. The return on equity ROE₁ in the first prediction year Y₁ may utilize the concept of earnings per share divided by averaged book value per share, and may be expressed as below using the projected earnings per share EPS₁ in the first prediction year Y₁, the projected book value per share BVPS₁ in the first prediction year Y₁, and the book value per share BVPS₀ in the base year Y₀ may be defined by the following

$${ROE}_{1} = {EPS}_{1} / [ \frac{( {BVPS}_{1} + {BVPS}_{0} )}{2} ]$$

In this embodiment, the return on equity ROE₁ in the first prediction year Y₁ is assumed to be equal to the historical return on equity ROE_{history}, we get, from calculation, that

$$ROEhistory = {EPS}_{1} / [ \frac{( {BVPS}_{1} + {BVPS}_{0} )}{2} ]$$

$$\frac{( {BVPS}_{1} + {BVPS}_{0} )}{2} = \frac{{EPS}_{1}}{ROEhistory} \\ [ \frac{( {BVPS}_{0} + {EPS}_{1} - {CDPS}_{1} ) + {BVPS}_{0}}{2} ] = \frac{{EPS}_{1}}{ROEhistory}$$

$$\frac{2 \times {BVPS}_{0} + {EPS}_{1} - {CDPS}_{1}}{2} = \frac{{EPS}_{1}}{ROEhistory}$$

$$\frac{2 \times {BVPS}_{0} - {CDPS}_{1}}{2} = {EPS}_{1} \times ( \frac{1}{ROEhistory} - \frac{1}{2} )$$

$${EPS}_{1} = ( 2 \times {BVPS}_{0} - {CDPS}_{1} ) \times {( \frac{ROEhistory}{2 - ROEhistory} )}_{\vert}$$

$${EPS}_{1} = ( {BVPS}_{0} - \frac{{CDPS}_{1}}{2} ) \times ( \frac{ROEhistory}{1 - \frac{ROEhistory}{2}} )$$

In this embodiment, the projected book value per share BVPS₁ in the first prediction year Y₁ may be the book value per share BVPS₀ in the base year Y₀ added by the projected earnings per share EPS₁ in the first prediction year Y₁ followed by being subtracted from the projected cash dividend per share CDPS₁ in the first prediction year Y₁ as stated above, that is,

BVPS₁=BVPS₀+EPS₁−CDPS₁.

According to this embodiment, by the same way, the projected earnings per share EPS₂, the projected cash dividend per share CPPS₂ and the projected book value per share BVPS₂ in the second prediction year Y₂ may be acquired from the mathematical expressions as below:

$${CDPS}_{2} = max ( 0 , {EPS}_{1} \times CDRhistory )$$

$${EPS}_{2} = ( {BVPS}_{1} - \frac{{CDPS}_{2}}{2} ) \times ( \frac{ROEhistory}{1 - \frac{ROEhistory}{2}} )$$

$${BVPS}_{2} = {BVPS}_{1} + {EPS}_{2} - {CDPS}_{2}$$

According to this embodiment, similarly, the evaluation factors of projected earnings per share, projected cash dividend per share and projected book value per share in the other prediction years may be generated based on the similar calculation process above.

In another embodiment, if a corporate with stock issuance has announced the cash dividend per share of the prediction year Y₁ before a valuation date, then the announced cash dividend per share is regarded as the projected cash dividend per share CDPS₁ in the prediction year Y₁, and the cash dividend payout ratio of the first prediction year is CDR₁=CDPS₁/EPS₀; the historical cash dividend payout ratio may be replaced with the average of cash dividend payout ratios of m years, including the known CDR₁, with an exemplary expression as below:

CDR_{average}=(CDR₁+CDR₀+CDR₋₁+ . . . +CDR₍₋ₘ₊₂₎_{)/m}

Referring again to FIG. 1, in step S15 of flow 100, the expected price Pₙ of the financial object in the last one year Yₙ in the plurality of prediction years may be generated based on the projected earnings per share EPSₙ of the last year in the plurality of prediction years and historical pricing-to-earnings ratio PER_{history}, wherein the historical price-to-earnings ratio PER_{history} may be generated based on the price-to-earnings ratio PERi before the valuation date.

What will that the expected price Pₙ be worth to an investor in the last one year Yₙ? That may depend on what price-to-earnings ratio the market is valuing the financial object in the last one year Yₙ.

In one example, the expected price-to-earnings ratio PERₑₛₜᵢₘₐₜₑ may be equal to the historical price-to-earnings ratio PER_{history}. Wherein the historical price-to-earnings ratio may be a mathematical combination of a plurality of price-to-earnings ratio before the valuation date; wherein the plurality of price-to-earnings ratio include at least one of: a plurality of time periods, a plurality of years, a plurality of quarters, or a plurality of accounting periods; and wherein the mathematical combination includes at least one of: calculating a mathematical average of the plurality of price-to-earnings, calculating a mathematical weighted average of the plurality of price-to-earnings ratio, calculating a statistical mean of the plurality of price-to-earnings ratio, calculating a statistical median of the plurality of price-to-earnings ratio, calculating a midpoint of the plurality of price-to-earnings ratio, or calculating a minimum of the plurality of price-to-earnings ratio.

In another example, the expected price-to-earnings ratio (PERₑₛₜᵢₘₐₜₑ) may be a given value, for example, 12.0.

In one embodiment, the expected price Pₙ of the financial object in the last year Yₙ of the plurality of prediction years may be the projected earnings per share EPSₙ in the last one year Yₙ of the plurality of prediction years multiplied by the historical price earnings ratio PER_{history}. The expected price may be defined by

Pₙ=EPSₙ×PER_{history}

In one embodiment, the historical price earnings ratio PER_{history} may be obtained by an itemized menu or a value filling process.

Referring again to FIG. 1, in step S16 of flow 100, the method according to the present invention may further include setting or selecting at least one requested return rate RATE_{(x %)}, and a fair value Pᵣₒ of the financial object may be generated based on the requested return rate RATE_{(x %)}, the projected cash dividend per share CDPSⱼ in the plurality of prediction years and the expected price Pₙ of the financial object in the last year Yₙ of the plurality of prediction years; in one embodiment, the requested return rate RATE_{(x %)} may be a predetermined value larger than zero; in another embodiment, the requested return rate RATE_{(x %)} may be a predetermined value larger than risk-free return rate.

In one embodiment, the fair value Pᵣₒ may be acquired by a compound discounting method. If the interval between the valuation date and the most recent dividend payout day of the cash dividend is over half year, an exemplary expression of the fair value Pᵣₒ is as below:

$${P}_{r 0} = \frac{{P}_{n}}{{( 1 + {RATE}_{( x \% )} )}^{n}} + {\sum }_{j = 1}^{n} \frac{{CDPS}_{j}}{{( 1 + {RATE}_{( x \% )} )}^{j}}$$

In another embodiment, if the interval between the valuation date and the most recent dividend payout day of the cash dividend is less than half year, an exemplary expression of the fair value Pᵣₒ is as below:

$${P}_{r 0} = \frac{{P}_{n}}{{( 1 + {RATE}_{( x \% )} )}^{n}} + {\sum }_{j = 1}^{n} \frac{{CDPS}_{j}}{{( 1 + {RATE}_{( x \% )} )}^{j - 1}}$$

In this embodiment, the requested return rate RATE_{(x %)} may be selected or setup with an itemized menu or a value filling method.

Additionally, the information of the plurality of securities may further include market price P₀ of each financial object in the plurality of securities; in one embodiment, the market price P₀ may be the real-time trading price per share or close price per share on the valuation date; in another embodiment, the market price P₀ may be the close price per share on the first trading day before the valuation date; in yet another embodiment, the market price P₀ may be an average close prices per share of plurality of trading days before the valuation date.

In one example, a value ratio of a financial object may be defined as 1−(market price)/(fair value) to evaluate whether there is a sufficient margin of safety for securities investment.

In another example, the value ratio of a financial object may be simply defined as (market price)/(fair value) to evaluate one financial object that is over valuated or under valuated.

In one exemplary embodiment, an expected return rate RATE of a financial object may be generated based on the market price P₀, the projected cash dividend per share CDPSⱼ, and the expected price Pₙ of the financial object in the last one year Yₙ of the plurality of prediction years.

In this embodiment, the derivation of the expected return rate RATE may be obtained from the equation following:

$${P}_{0} = \frac{{P}_{n}}{{( 1 + RATE )}^{n}} + {\sum }_{j = 1}^{n} \frac{{CDPS}_{j}}{{( 1 + RATE )}^{j}}$$

In one example, an user may determine rise room or fall room of the financial object by comparing the difference between the market price P₀ and the fair value Pᵣ₀ or the value ratio.

In another example, an user may also utilize the expected return rate RATE to evaluate whether the financial object has satisfactory investment value, or compare relative values between different securities.

In one embodiment, an itemized menu process may be used to obtain some parameters including at least one of historical return on equity, historical cash dividend payout ratio, historical price-to-earnings ratio, or request return rate. It's useful to simplify securities analysis work.

In one example, it is applicable to all of the plurality of securities with respect to setting or selecting evaluation conditions of historical return on equity (ROE), historical price-to-earnings ratio (PER), requested return rate with a itemized menu or value filling process. For example, average of ROEs of five years as historical ROE, median of PERs of three years as historical PER, 15% as requested return rate may be applicable to each financial object in the plurality of securities.

In another example, different historical ROE, historical PER, or requested return rate may be set or selected for different financial object. For example, the historical ROE for financial object A may be set as the average of ROEs of the most recent 5 years, while that for financial object B may be set as the average of ROEs of the most recent 3 years, to adapt to different industrial characteristics or economic cycles of corporate with stock issuance such that the flexibility and practicability of the invention may be improved.

The aforementioned computer-implemented method for evaluating securities investment value may be implemented by a computer program product for storing securities information process program. The aforementioned computer program product may be, for example, electronic equipment such as computer, network server (for example, cloud equipment), or mobile device (for example, smart phone) etc. or storage media etc., but not limited thereto. After investors execute the securities information process program stored in the aforementioned electronic equipment, or execute the securities information process program stored in electronic device that may read the securities information process program stored in the storage media, various methods of the invention mentioned above may be implemented. The aforementioned methods of the invention may also be implemented in specific data process systems.

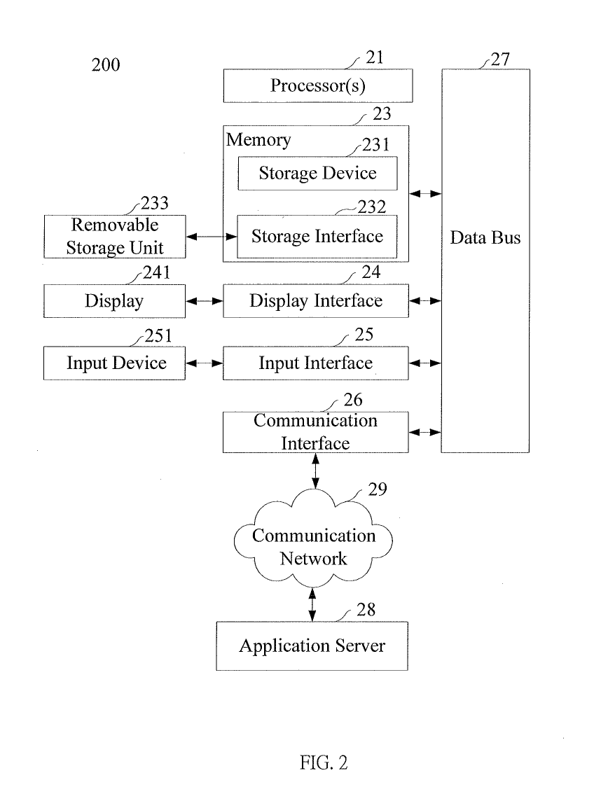

FIG. 2 depicts an exemplary computer system that may be used in implementing an exemplary embodiment of the present invention. Referring to FIG. 2, which illustrates a computer system 200 may be utilized in an electronic calculation device, but not limited to the application for client terminal device and/or server device etc. The computer program product of the invention may be implemented on any appropriate computer system running any appropriate operating system. The operating system (e.g., WINDOWS, LINUX, iOS, ANDROID, or an embedded operating system, but not limited thereto.) includes various software components and/or devices for controlling and managing general system tasks.

The computer system 200 may include one or more processors 21, which may be connected to data bus 27. The computer system 200 may also include memory 23. The memory 23 may include a storage device 231 of non-volatile storage such as hard disk, storage type Flash memory (NAND flash), or other non-volatile solid-state memory devices for storing the application program formed according to the present invention. The memory 23 may also include a storage interface 232, for example, but not limited to, optical disk drive, USB socket, memory card socket etc. The computer system 200 may also include a removable storage unit 233. The removable storage unit 233 may also referred to as program storage device or computer program product, for example, optical disk, USB drive, memory card etc. The removable storage unit 233 may access to the storage interface 232 with data. The program stored in the memory 23 is configured to be executed by the one or more processors.

The computer system 200 may include an input interface 25 and an input device 251. The input device 251 may be, but not limited to, touch panel, mouse, keyboard, or other input peripheral products. The input device may allow an user to enter a securities name to select a financial object, or may allow an user to set evaluation factors, for example, requested return rate, historical return on equity (ROE), or historical price-to-earnings ratio etc. with a menu or value filling method, but not limited thereto.

The computer system 200 may include a display interface 24 and a display 241. In one example, the display 241 may allow a user to acquire fair value, market price, requested return rate etc. with a text or graph method, but not limited thereto.

The computer system 200 may include a communication interface 26, for example, but not limited to network interface card and modem. The computer system 200 may link to a communication network 29 through a communication interface 26 to transfer software and data to and from an application server 28. The communication network 29 may be an internet or a dedicated network. In one example, the computer system 200 may link to a securities database (not shown) in the application server 28 through the communication interface 26 after loading the computer program product for storing the securities information process program to perform the computer implemented method for securities investment. In another example, the data in the securities database may also be loaded completely to the memory 23 through the communication interface 26, or stored in the storage unit 231 of the memory 23 directly with an artificial operation or automatic importing process.

Users may utilize the input device 251 to send parameters, which control the execution of the program, to the processor 21 through the input interface 25, and guide the execution of the program. The parameters for program execution may include, for example, a method for generating historical return on equity (ROE), a method for generating historical cash dividend payout ratio, a method for generating historical price-to-earnings ratio (PER), filled or selected requested return rate, and securities name of financial object, but not limited thereto. The result from the program execution performed by the processor 21 may be sent to the display 241 through the display interface 24 with texts or graphs for users to reference and apply. The result from the program execution may include fair value of financial object, but not limited thereto.

In one exemplary embodiment, the present invention may be provided as a computer program product, which may be downloaded and stored in a computer. Users may send the program from an application program issuance platform to a memory 23 of a client computer through a communication interface 26 (for example, modem or wireless network) of a computer, and then execute a securities information process program stored in the computer program product on the computer. The application program issuance platform may be, for example, but not limited thereto, Google Play™ of Android™ operating system or App Store of iOS operating system from Apple® Inc.

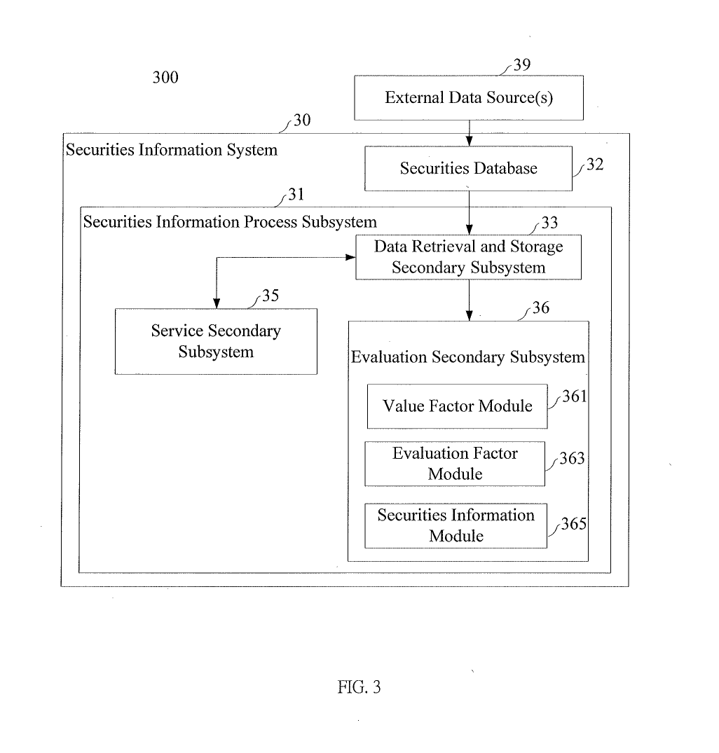

FIG. 3 depicts an exemplary securities information system that may be used in implementing some exemplary embodiments of the present invention. Refer to FIG. 3, which illustrates a block diagram 300 applied to a computer-implemented program for evaluating securities investment according to the invention. The securities information system 30 may include a securities database 32. The securities database 32 according to an exemplary embodiment, may store identity, accounting data, price-to-earnings ratio, and/or other data, metrics, measures, parameters, and/or factors for each financial object in a plurality of securities, obtained from an external data source(s) 39 with an artificial or automatic process method. The accounting data may include, according to an exemplary embodiment, at least book value per share, earning per share, and cash dividend per share of each of the plurality of securities in the securities database 32. The securities information system 30 may include a securities information process subsystem 31 coupled to the securities database 32. In one exemplary embodiment, securities information process subsystem 31 may be a computer apparatus such as a client electronic device (not shown). In this embodiment, the securities database 32 and the securities information process subsystem 31 may not be at the same computer apparatus.

The securities information process subsystem 31 may include a service secondary subsystem 35, which provides external users to select at least one financial object by identity of the financial object on a valuation date. Wherein the financial object is one of the plurality of securities. The securities information process subsystem may include a data retrieval and storage secondary subsystem 33, which may compares the identity of the financial object provided by the service secondary subsystem 35, link the securities database 32 to acquire the information related to the financial object. The securities information process subsystem 31 may include a evaluation secondary subsystem 36, which may link to the data retrieval and storage secondary subsystem 33, and accept the securities data related to the financial object. The evaluation secondary subsystem 36 may include a value factor module 361, which may setup a number of pluralities of historical years for evaluation by default to generate value factors. The value factors include historical return on equity (ROE), historical cash dividend payout ratio, book value per share in a base year, and earnings per share (EPS) in the base year. The base year may be composed of four consecutive quarters with available financial accounting data before the valuation date. The evaluation secondary subsystem 36 may include an evaluation factor module 363, which may setup a number of a plurality of prediction years necessary for evaluation by default, and further generate evaluation factors of the financial object in the plurality of prediction years after the base year based on the value factors provided by the value factor module 361. The evaluation factors include: projected earnings per share, projected cash dividend per share, and projected book value per share. The evaluation secondary subsystem 36 may include a securities information module 365 to generate an expected price of the financial object in the last one year of the plurality of prediction years based on the evaluation factors provided by the evaluation factor module 363 and historical price-to-earnings ratio (PER), wherein the historical PER may be generated based on the price-to-earnings ratio of the financial object before the valuation date provided by the data retrieval and storage subsystem 33, or a predetermined value built-in the securities information module 365.

According to an exemplary embodiment, the securities information module 365 may also build-in a predetermined value for at least one requested return rate. The securities information module 365 may generate a fair value of the financial object based on the expected price of the financial object in the last one year of the prediction years, the expected cash dividend per share of the financial object in the prediction years provided by the evaluation factor module 363, and the requested return rate here.

According to another exemplary embodiment, the information in the securities database 32 may also store market prices of each financial object in the plurality of securities. The securities information module 365 may generate an expected return rate of the financial object based on the expected price of the financial object in the last year of the plurality of prediction years, the market price of the financial object acquired by retrieval from the securities database 32 performed by the data retrieval and storage secondary subsystem 33, and the projected cash dividend per share of the financial object in the plurality of prediction years provided by the evaluation factor module 363.

The securities information module 365 may also generate at least one value ratio of the financial object based on the fair value of the financial object and the market price of the financial object acquired by retrieval from the securities database 32 performed by the data retrieval and storage secondary subsystem 33.

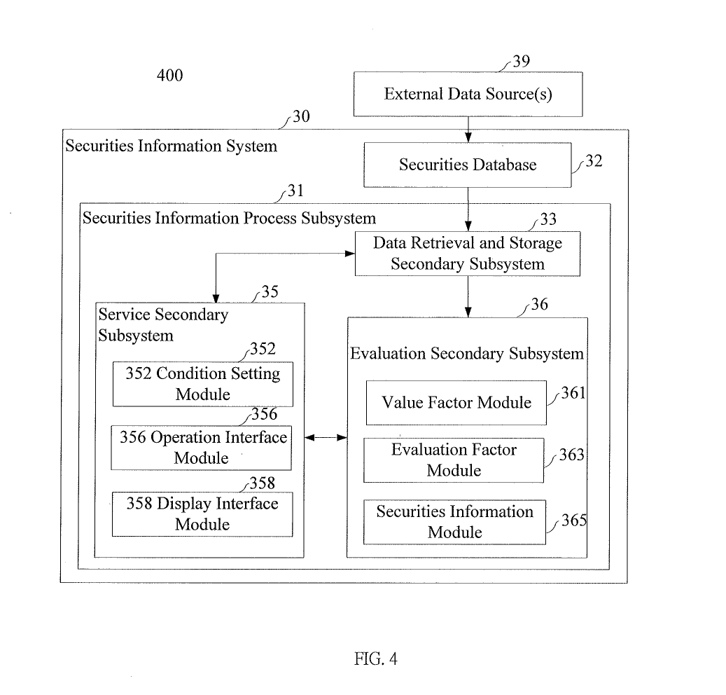

Refer to FIG. 4, which illustrates another block diagram 400 applying a computer-implemented method for securities investment evaluation according to the present invention. A securities information process subsystem 31 may include a service secondary subsystem 35. According to one exemplary embodiment, the service secondary subsystem 35 may further include a condition setting module 352, an operation interface module 356, and a display interface module 358. Users may input at least one identity of a financial object selected by an input element, such as touch panel, keyboard etc. to the operation interface module 356, and may also utilize an itemized menu or a value filling method through the operation interface module 356 to set evaluation factors, for example, requested return rate, historical return on equity (ROE), or historical price-to-earnings ratio (PER). A display interface module may show selectable value ranges or options of various evaluation factors in a text or graph method through a display panel. The condition setting module 352 may link to an evaluation secondary subsystem 33 for users to change setting conditions of evaluation factors, for example, but not limited to, setting value of requested return rate, setting condition of historical ROE, setting condition of cash dividend payout ratio, or setting condition of historical PER, or may form the setting conditions of the evaluation factors as options to show on a screen through the display interface module 358 for users to set or select the setting conditions of various evaluation factors by themselves. Additionally, the historical ROE or historical PER for individual financial object may be further set to be different from one another. In one example, the condition setting module 352 may set the setting conditions of evaluation factors, including, but not limited to, requested return rate as 15%, historical ROE as an average of ROEs in five years before the valuation date, historical cash dividend payout ratio as an average of cash dividend payout ratios in five years before the evaluation day, and/or historical PER as a median of PERs in five years before the valuation date. The condition setting module 352 may also provide a menu for setting conditions of evaluation factors to show on a display device connected to the interface module 358 for users to select the condition setting options of the evaluation factors through the operation interface module 356 by the use of input device conveniently.

Referring to FIG. 4, the securities information process subsystem may include a data retrieval and storage secondary subsystem 33 and an evaluation secondary subsystem 36. The service secondary subsystem 35 may send the identity of the financial object to the data retrieval and storage secondary subsystem 33. The data retrieval and storage secondary subsystem 33 links to the securities database 32 to check the identity, after that, may collect and calculate the accounting data and/or price-to-earnings ratio of the financial object, and send to the evaluation secondary subsystem 36.

The evaluation secondary subsystem 36 may include a value factor module 361, an evaluation factor module 363. The value factor module 361, along with the condition setting module 352, calculates accounting data related to the financial object to generate and provide value factors to the evaluation factor module 363 for condition setting of historical return on equity (ROE) and historical cash dividend payout ratio (the condition setting may be a system default value or an user defined value). The value factors may include historical ROE, historical cash dividend payout ratio, and earnings per share (EPS) in a base year, and book value per share in the base year. The evaluation factor module 363 may input the number of the plurality of prediction years after the base year set by the condition setting module, and is used to calculate the evaluation factors of the-financial object in the plurality of prediction years based on the value factors of the value factor module 361. The evaluation factors include projected earnings per share (EPS), projected cash dividend per share and projected book value per share. The evaluation secondary subsystem 36 may include a securities information module 365, together with the evaluation factors provided by the evaluation factor module 363 and the condition setting for historical price-to-earnings ratio (PER) performed by the condition setting module 352 to calculate the expected earnings per share (EPS) and expected PER of the last one year in the plurality of prediction years after the base year for generating expected price of the financial object.

Additionally, the evaluation secondary subsystem 36 may also include a securities information module 365 to generate fair value or expected return rate of a financial object. The securities information module 365 may generate the fair value of the financial object by using the expected price of the financial object in the last one year of the prediction years, the requested return rate set by the condition setting module 355, together with the projected cash dividend per share of the financial object generated by the evaluation factor module 363 and the number of the plurality of prediction years. The information in the securities database 32 may also include market prices of each financial object in the plurality of securities. The data retrieval and storage secondary subsystem 43 may also contain the market price of the financial object when it checks the identity of the financial object selected by the information service subsystem 35 to retrieve the information from the securities database 32. The securities information module 365 may generate expected return rate of the financial object based on the market price of the financial object registered in the data retrieval and storage secondary subsystem 33, the expected cash dividend per share of the financial object sent from the evaluation factor module 363, the expected price of the financial object in the last one year of the plurality of prediction years, and the number of the plurality of prediction years.

According to one exemplary embodiment, the securities database 32 and the securities information process subsystem 31 of the securities information system 30 in the invention may be located in a single computer apparatus.

According to another exemplary embodiment, the securities database 32 may be stored in a remote application server to connect with the securities information process subsystem 31 at client and perform data transfer through internet or a dedicated network method. The securities information process subsystem 31 is built in a client electronic device in software form. The client electronic device may be, for example, but not limited to, personal computer, tablet PC, or smart phone, and particularly, may perform data exchange with a remote server storing the securities database 32 through wireless communication method or internet. The securities information process subsystem 31 may accept user selection and setting entered from a client electronic device operated by users. The securities information process system 31 may issue a query request for any financial object to the securities database 32 through the remote application program server according to the financial object selected by the user, and the securities database 32 returns respective information.

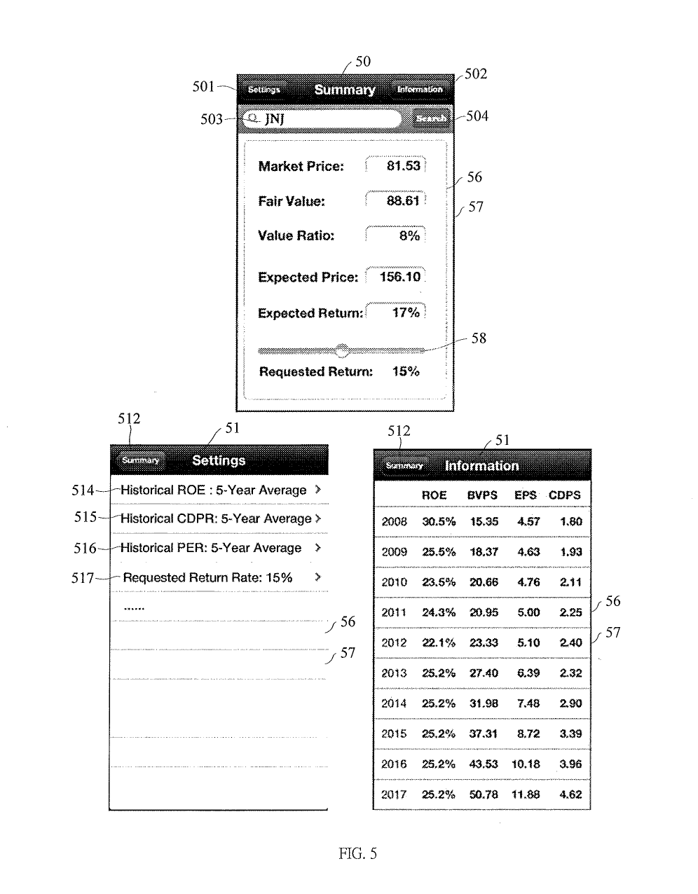

Attention is now directed towards a preferred embodiment of the present invention. FIG. 5 illustrates an exemplary user interface of a computing device with touch screen display in accordance with a preferred embodiment of the invention. Referring to FIGS. 3 and 5, three user interfaces are shown, including Summary page 50, Settings page 51, and Information page 52. The above three securities information pages all have display screen 56 connected to the display interface module 358 for a user to see securities information process subsystem 31 related securities information. Also, there are touch panel 57 linked to the operation interface module 356 to provide the user with necessary setting or selection function. In Summary page 50, a user may click Settings button 501 through the touch panel 57 to display the Settings page 51. By the same way, the Information page 52 may be displayed if Information button 502 is clicked. The Summary page 50 may be returned once the Summary button 512 is clicked on the Settings page 51. By the same way, the Summary page 50 may also be displayed back by clicking the Summary button 522 on the Information page 52. Additionally, on the Summary page 50, a search field 503 is used for a user to enter one ticker symbol or name of financial object, followed by clicking a Search button 504 to select a financial object, wherein the financial object is one of the plurality of securities in the securities database 32. After selecting at least one financial object selected, such that the operation interface module 356 is linked, and the information of the financial object is retrieved from the securities database 32 in the remote server (not shown) through the data retrieval and storage secondary subsystem 33. The information of the financial object will be sent to the evaluation secondary subsystem 36 to generate and show value factors, evaluation factors, and related securities data on the Information page 52 for the user's reference. A requested return rate setting slider 58 may allow for users to set desired return rates of any financial object. The Settings page 51 may display default condition fields for all securities in the system, including, but not limited to, setting condition field for Historical ROE 514 with respect to historical return on equity, setting condition field for Historical CDPR 515 with respect to historical cash dividend payout ratio, setting condition field for Historical PER 516 with respect to historical price-to-earnings ratio, and setting condition field for Requested Return Rate 517 with respect to requested return rate. In one exemplary embodiment, the default values in the system may include: 15% for the requested return rate setting value, 5-year average for the historical price-to-earnings ratio. In the initial picture on the Summary page 50, the requested return rate shows 15%.

Referring again to FIGS. 5 and 3, in one exemplary embodiment, if an user wants to evaluate the investment value of Stock J on Apr. 1, 2013, the valuation date, the user may input the ticker symbol, JNJ, of Stock J in the Search field 503, followed by clicking the Search button 504 to select Stock J, such that the data retrieval and storage secondary subsystem 33 is notified through the operation interface module 356 for linking to the securities database 32 in the remote application server to download and send the information of Stock J to the evaluation secondary subsystem 36. Then, the securities information module 365 displays related information on the display screen 56 of the Summary page 50 through the display interface module 358, including, but not limited to, market price, fair value, value ratio, expected return rate. The user may estimate roughly the investment value of Stock J according to the information of stock J above. In this preferred embodiment, the current market price of Stock J (the close price of the first trading day before the valuation date) is traded at $81.53 a share, the expected return rate may be generated about 17% based on the historical return on equity (ROEhistory) as the average return on equity (ROEaverage) in the past 5 years for 25.2% as well as the projected cash dividend per share from 2013 to 2017 under consideration. On the other hand, the current fair value of Stock J may be generated for $88.61 a share based on the requested return rate in the condition setting, 15%, is to be achieved. The user may click the Information button 502 to enter the Information page 52 for further understanding the evaluation process with respect to the investment value of Stock J.

The Information page 52 shows the securities information after Stock J is selected by the user. Because the corporate issuing stocks of Stock J has announced the financial statement of the fourth quarter in 2012 and the financial statement of 2012 before Apr. 1, 2013, the four consecutive quarters with available accounting data of Stock J before the valuation date may be from the first quarter of 2012 to the fourth quarter of 2012, that is, the base year is 2012, and the plurality of historical years before the evaluation day may be from 2008 to 2012. The information of Stock J may include, but not limited to, return on equity (ROE), book value per share, earnings per share (EPS), cash dividend per share, and cash dividend payout ratio from 2008 to 2012. The value factors of Stock J may be calculated as below:

Historical return on equity=(30.5%+25.5%+23.5%+24.3%+22.1%)/5=25.2%

Historical cash dividend payout ratio=(1.80+1.93+2.11+2.25+2.40)/(4.15+4.57+4.63+4.76+5.00)=45.4%

Wherein EPS in 2007 is 4.15 (not shown)

EPS in the base year (2012)=5.10

Book value per share in the base year (2012)=23.33

In this preferred embodiment, the plurality of prediction years after the base year may be from 2013 to 2017. To adapt to the example that return on equity (ROE) may be defined as earnings per share (EPS) divided by average book value per share of the same year, the evaluation factors of Stock J may be calculated with aforementioned mathematical expressions as below:

Projected cash dividend per share of 2013=5.10×45.4%=2.32

Projected EPS of 2013=(23.33−2.32/2)×(25.2%/(1−(25.2%/2)))=6.39

Projected book value per share of 2013=23.33+6.39−2.32=27.40

Projected cash dividend per share of 2014=6.39×45.4%=2.90

Projected EPS of 2014=(27.40−2.90/2)×(25.2%/(1−(25.2%/2)))=7.48

Projected book value per share of 2014=27.40+7.48−2.90=31.98

(and so forth)

Projected cash dividend per share of 2017=10.18×45.4%=4.62

Projected EPS of 2017=(43.52−4.62/2)×(25.2%/(1−(25.2%/2)))=11.88

Projected book value per share of 2017=43.52+11.88−4.62=50.78

In the preferred example, the price-to-earnings ratio (PER) of Stock J for the plurality of historical years (not shown) are contained within the annual report of the given years as below:

| YEAR | PER (Price-to-earnings Ratio) |
|---|---|
| 2008 | 14.3 |
| 2009 | 12.5 |
| 2010 | 13.1 |
| 2011 | 12.7 |
| 2012 | 13.1 |

The expected price-to-earnings ratio (PER) that the market is valuing the stock J in 2017 is set as the historical price-to-earnings ration based on the average of PER for five years (2008-2012) according to the Settings page,

Historical PER of Stock J=(14.3+12.5+13.1+12.7+13.1)/5=13.14

Expected price of Stock J in 2017=11.88×13.14=156.1

The current fair value of Stock J based on the requested compounding annual return rate of 15% for the five-year period is estimated as below:

The present value of the expected price=156.1/(1+15%)⁵=77.61

$$The present value of the projected cash dividend = \frac{2.32}{1 + 15 \%} + \frac{2.90}{{( 1 + 15 \% )}^{2}} + \frac{3.39}{{( 1 + 15 \% )}^{3}} + \frac{3.96}{{( 1 + 15 \% )}^{4}} + \frac{4.62}{{( 1 + 15 \% )}^{5}} = 11.0$$

Fair value of Stock J=77.61+11.0=88.61

In this preferred embodiment, the value ratio may be defined as 1−(market price)/(fair value) to evaluate whether there is sufficient safety of margin for Stock J.

Value ratio of Stock J=1−(81.53/88.61)=8%

In the example, the expected return rate (RATEe) of Stock J may be derived from the following expressions:

$$81.53 = \frac{156.1}{{( 1 + {RATE}_{e} )}^{5}} + \frac{2.32}{( 1 + {RATE}_{e} )} + \frac{2.90}{{( 1 + {RATE}_{e} )}^{2}} + \frac{3.39}{{( 1 + {RATE}_{e} )}^{3}} + \frac{3.96}{{( 1 + {RATE}_{e} )}^{4}} + \frac{4.62}{{( 1 + {RATE}_{e} )}^{5}}$$

Thus, the resultant expected return rate of Stock J, RATEe=17.03%

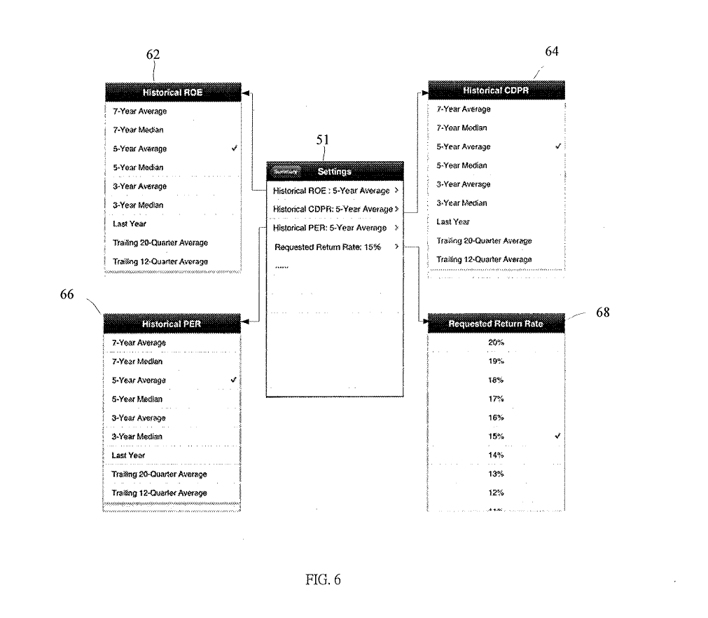

Referring again to FIGS. 5 and 6, the user may set related evaluation parameters on the Settings page 51. In an exemplary embodiment, the user may click the condition setting field for Historical ROE 514 on the settings page 51 to enter the Historical ROE page 62. A plurality of options is displayed with an itemized menu. The user may select one of the options in the itemized menu. As returning to the Settings page 51, the setting condition of the condition setting field for Historical ROE 514 will also be updated as the selected option. By the similar way, the user may select options of respective evaluation parameters by setting historical cash dividend payout ratio by the Historical CDPR page 64, setting historical price-to-earnings ratio by the Historical PER page 66, setting requested return rate by the Historical CDPR page 68, respectively to build their own investment decision architecture. As the user click the Summary button 512 to return the Summary page 50, the securities information system will implement the updated setting conditions to evaluate the selected financial object.

Users may construct their own robust investment architecture with the computer-implemented method, computer program product, and securities information system according to the present invention.

In summary, the invention utilizes securities data in trading and fundamental aspects to quantify the value factors and evaluation factors used to determine corporate financial quality and securities investment quality, and further produce expected return rate of securities for investors to evaluate investment value of securities and relative values between securities with concrete data, and is an invention with objectivity and integrity.

What is claimed is:

1. A computer-implemented method for evaluating securities value, the method comprising:
storing information of a plurality of securities into a database, wherein said information comprises: identity, accounting data and price-to-earnings ratio of each of said plurality of securities;
selecting at least one financial object by the identity of said financial object on a valuation date, wherein said financial object is one of said plurality of securities;
generating value factors of said financial object based on the accounting data of said financial object; wherein said value factors comprise: historical return on equity, historical cash dividend payout ratio, book value per share in a base year and earnings per share in said base year; wherein said base year consists of four consecutive quarters before said valuation date;
generating evaluation factors of said financial object in a plurality of prediction years after said base year based on the value factors of said financial object, wherein said evaluation factors comprise: projected earnings per share, projected cash dividend per share, and projected book value per share; and
generating expected price of said financial object in the last year of said plurality of prediction years based on said evaluation factors and historical price-to-earnings ratio of said financial object, wherein said historical price-to-earnings ratio is generated based on the price-to-earnings ratio of said financial object before said valuation date.

2. The computer-implemented method of claim 1, wherein said accounting data comprises: book value per share, earnings per share and cash dividend per share.

3. The computer-implemented method of claim 1, wherein said historical price-to-earnings ratio is a mathematical combination of a plurality of price-to-earnings ratio before said valuation date;
wherein said plurality of price-to-earnings ratio comprise at least one of:
a plurality of time periods;
a plurality of years;
a plurality of quarters; or
a plurality of accounting periods; and
wherein said mathematical combination comprises at least one of:
calculating a mathematical average of said plurality of price-to-earnings ratio;
calculating a mathematical weighted average of said plurality of price-to-earnings ratio;
calculating a statistical mean of said plurality of price-to-earnings ratio;
calculating a statistical median of said plurality of price-to-earnings ratio;
calculating a midpoint of said plurality of price-to-earnings ratio; or
calculating a minimum of said plurality of price-to-earnings ratio.

4. The computer-implemented method of claim 3, wherein said historical price-to-earnings ratio is obtained by using an itemized menu, wherein said itemized menu is generated based on said mathematical combination of said plurality of price-to-earnings ratio.

5. The computer-implemented method of claim 2, wherein said historical return on equity is a mathematical combination of a plurality of return on equity before said valuation date;
wherein said plurality of return on equity comprise at least one of:
a plurality of time periods;
a plurality of years;
a plurality of quarters; or
a plurality of accounting periods; and
wherein said mathematical combination comprises at least one of:
calculating a mathematical average of said plurality of return on equity;
calculating a mathematical weighted average of said plurality of return on equity;
calculating a statistical mean of said plurality of return on equity;
calculating a statistical median of said plurality of return on equity;
calculating a midpoint of said plurality of return on equity; or
calculating a minimum of said plurality of return on equity.

6. The computer-implemented method of claim 5, wherein said historical return on equity is obtained by using an itemized menu, wherein said itemized menu is generated based on said mathematical combination of said plurality of return on equity.

7. The computer-implemented method of claim 2, wherein said historical cash dividend per share is a mathematical combination of a plurality of cash dividend per share before said valuation date;
wherein said plurality of cash dividend per share comprise at least one of:
a plurality of time periods;
a plurality of years;
a plurality of quarters; or
a plurality of accounting periods; and
wherein said mathematical combination comprises at least one of:
calculating a mathematical average of said plurality of cash dividend per share;
calculating a mathematical weighted average of said plurality of cash dividend per share;
calculating a statistical mean of said plurality of cash dividend per share;
calculating a statistical median of said plurality of cash dividend per share;
calculating a midpoint of said plurality of cash dividend per share; or
calculating a minimum of said plurality cash dividend per share.

8. The computer-implemented method of claim 1, wherein said generating evaluation factors of said financial object comprises:
calculating projected cash dividend per share of said financial object in a first prediction year after said base year based on the earnings per share of said financial object in said base year and the historical cash dividend payout ratio of said financial object; wherein said first prediction year is the first year not overlapped with said base year counted after said base year,
calculating the projected earnings per share of said financial object in said first prediction year based on the book value per share of said financial object in said base year and the historical return on equity of said financial object;
calculating the projected book value per share of said financial object in said first prediction year based on the book value per share of said financial object in said base year, the projected earnings per share of said financial object in said first prediction year, and the projected cash dividend per share of said financial object in said first prediction year;
calculating the projected cash dividend per share of said financial object in a second prediction year after said base year based on the projected earnings per share of said financial object in said first prediction year and said historical cash dividend payout ratio of said financial object; wherein said second prediction year is the second year not overlapped with said first prediction year counted after said base year;
calculating the projected earnings per share of said financial object in said second prediction year based on the projected book value per share of said financial object in said first prediction year and the historical return on equity of said financial object; and
calculating the projected book value per share of said financial object in said second prediction year based on the projected book value per share of said financial object in said first prediction year, the projected earnings per share of said financial object in said second prediction year, and the projected cash dividend per share of said financial object in said second prediction year.

9. The computer-implemented method of claim 1, further comprising:
selecting at least one requested return rate, and
generating a fair value of said financial object based on said requested return rate, said projected cash dividend per share of said financial object in said plurality of prediction years, and said expected price of said financial object in the last year of said plurality of prediction years.

10. The computer-implemented method of claim 9, wherein, said information further comprises market price of each of said plurality of securities, and a value ratio of said financial object is generated based on the market price and the fair value of said financial object.

11. The computer-implemented method of claim 1, wherein said information further comprises market price of each of said plurality of securities, and an expected return rate of said financial object is generated based on the market price of said financial object, the projected cash dividend per share of said financial object in said plurality of prediction years, and the expected price of said financial object in the last year of said plurality of prediction years.

12. The computer-implemented method of claim 11, wherein said market price comprises at least one of:
a trading price which is real-time or delay times on said valuation date;
a close price on said valuation date;
a close price on the first trading day before the valuation date; or
an average of close prices of a plurality of trading days before said valuation date;

13. The computer-implemented method of claim 1, wherein said plurality of securities are selected from a universe, comprising at least one of:
a sector;
a market;
a market sector;
an industry sector;
a geographic sector; or
an international sector.

14. A computer program product embodied on a non-transitory computer readable medium for evaluating securities value, wherein said computer program product comprises a set of instructions that when executed by a computer system allows the computing system to implement the following steps, comprising:
linking to a database operative to store information of a plurality of securities, wherein said information comprises identity, accounting data and price-to-earnings ratio of each of said plurality of securities;
selecting at least one financial object by the identity of said financial object on a valuation date, wherein said financial object is one of said plurality of securities;
generating value factors of said financial object based on the accounting data of said financial object, wherein said value factors comprise historical return on equity, historical cash dividend payout ratio, book value per share in a base year and earnings per share in said base year; wherein said base year consists of four consecutive quarters before said valuation date;
generating evaluation factors of said financial object in a plurality of prediction years after said base year based on the value factors of said financial object, wherein said evaluation factors comprise: projected earnings per share, projected cash dividend per share, and projected book value per share; and
generating expected price of said financial object in the last year of said plurality of prediction years based on the evaluation factors and historical price-to-earnings ratio of said financial object, wherein said historical price-to-earnings ratio is generated based on the price-to-earnings ratio of said financial object before said valuation date.

15. The computer program product of claim 14, further comprising:
selecting at least one requested return rate, and
generating a fair value of said financial object based on said requested return rate, the projected cash dividend per share of said financial object in said plurality of prediction years, and the expected price of said financial object in the last year of said plurality of prediction years.

16. The computer program product of claim 14, wherein said information further comprises market price of each of said plurality of securities, and an expected return rate of said financial object is generated based on the market price of said financial object, the projected cash dividend per share of said financial object in said plurality of prediction years, and the expected price of said financial object in the last year of said plurality of prediction years.

17. A system for evaluating securities value, comprising:
a database operative to store information of a plurality of securities, wherein said information comprises identity, accounting data and price-to-earnings ratio of each of said plurality of securities; and
a securities information process subsystem linked to said database, comprising:
a service secondary subsystem operative to select at least one financial object by the identity of said financial object on a valuation date, wherein said financial object is one of said plurality of securities;
a data retrieval and storage secondary subsystem operative to at least one of access, or retrieve said information from said database based on said identity of said financial object selected by said service secondary subsystem; and
an evaluation secondary subsystem linked to said data retrieval and storage secondary subsystem, comprising:
a value factor module operative to generate value factors of said financial object based on the accounting data of said financial object provided by said data retrieval and storage secondary subsystem, wherein said value factors comprise: historical return of equity, historical cash dividend payout ratio, book value per share in a base year and earnings per share in said base year; wherein said base year consists of four consecutive quarters before said valuation date;
an evaluation factor module operative to generate evaluation factors of said financial object in a plurality of prediction years after said base year based on said value factors provided by said value factor module, wherein said evaluation factors comprise: projected earnings per share, projected cash dividend per share, and projected book value per share; and
a securities information module operative to generate an expected price of said financial object in the last year of said plurality of prediction years based on said evaluation factors provided by said evaluation factor module and historical price-to-earnings ratio of said financial object, wherein said historical price-to-earnings ratio is generated based on the price-to-earnings ratio of said financial object before the valuation date provided by said data retrieval and storage secondary subsystem.

18. The system of claim 17, wherein, said information in said database further comprises market price of each of said plurality of securities, and said securities information module further generates an expected return rate of said financial object based on the expected price of said financial object in the last year of said plurality of prediction years, the market price of said financial object provided by said data retrieval and storage secondary subsystem, and said projected cash dividend per share of said financial object in said plurality of prediction years provided by said evaluation factor module.

19. The system of claim 17, wherein said service secondary subsystem further comprises a condition setting module operative to select at least one requested return rate; and
said securities information module further generating a fair value of said financial object based on the expected price of said financial object in the last year of said plurality of prediction years, said projected cash dividend per share of said financial object in said plurality of prediction years provided by said evaluation factor module, and said requested return rate provided by said condition setting module.

20. The system of claim 17, wherein, said service secondary subsystem further comprises:
a display interface module operative to display a menu with a plurality of values provided by said condition setting module; and
an operation interface module operative to obtained said requested return rate by selecting at least one option from said menu.
